(19) United States
(12) Patent Application Publication
(10) Pub. No.: US 2024/0078499 A1
(43) Pub. Date: Mar. 7, 2024

(54) SYSTEM FOR MONITORING TRANSPORTATION, LOGISTICS, AND DISTRIBUTION FACILITIES

(71) Applicant: KoiReader Technologies, Inc., Dallas, TX (US)

(72) Inventors: Ashutosh Prasad, Dallas, TX (US); Vivek Prasad, Bengaluru (IN)

(73) Assignee: KoiReader Technologies, Inc., Dallas, TX (US)

(21) Appl. No.: 18/259,435

(22) PCT Filed: Dec. 29, 2021
(86) PCT No.: PCT/US21/73150

§ 371 Date: Jun. 27, 2023

Related U.S. Application Data
(60) Provisional application No. 63/199,456, filed on Dec. 30, 2020.

(51) Int. Cl. G06Q 10/083

(52) U.S. Cl. CPC G06Q 10/083

(57) ABSTRACT

Techniques for detecting anomalies, issues, and/or damage associated with operations of a transportation/logistic facility, vehicles collecting and delivering assets to and from the facility, and containers associated with the operations and transportation of the assets. In some cases, the system may be configured to capture data associated with an operation using multiple sensor systems and to detect the anomalies based in part on the aggregated sensor data.

### CROSS-REFERENCE TO RELATED APPLICATION(S)

This application claims priority to U.S. Provisional Application No. 63/199,456 filed on Dec. 30, 2020 and entitled “SYSTEM FOR MONITORING TRANSPORTATION, LOGISTICS, AND DISTRIBUTION FACILITIES,” which is incorporated herein by reference in its entirety.

### BACKGROUND

Facilities associated with the transporting and shipping of assets may experience anomalies or other issues when operations are performed with respect to the assets, asset containers, and/or transportation vehicles. These anomalies may cause damage or injury to the assets, the containers, the vehicles, facility equipment, and/or facility personnel. In some cases, transport vehicles, containers, and/or systems may also suffer damage during transit prior to entering the facility. Conventionally, inspections are performed manually and are, thereby, time consuming and prone to errors. Further, the manual inspections are performed when a vehicle enters a facility and prior to commencing operations. In this manner, manual inspections fail to provide any type of issue, damage, or anomaly detection associated with facility operations.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a maintenance and repair operations system for determining a status, assessing damage, and initiating repairs of transport vehicles.

FIG. 2 is a flow diagram illustrating an example process associated with monitoring facility operations according to some implementations.

FIG. 3 is a flow diagram illustrating an example process associated with monitoring facility operations according to some implementations.

FIG. 4 is a flow diagram illustrating an example process associated with assessing transport vehicles according to some implementations.

FIG. 5 is an example sensor system that may implement the techniques described herein according to some implementations.

FIG. 6 is an example facility management system that may implement the techniques described herein according to some implementations.

FIG. 7 is an example pictorial diagram of a potential anomaly associated with a facility detectable by the facility management system of FIGS. 1-6 according to some implementations.

FIG. 8 is another example pictorial diagram of a potential anomaly associated with a facility detectable by the facility management system of FIGS. 1-6 according to some implementations.

FIG. 9 is yet another example pictorial diagram of a potential anomaly associated with a facility detectable by the facility management system of FIGS. 1-6 according to some implementations.

FIG. 10 is an example pictorial diagram of an area associated with a facility for positioning sensor systems of the facility management system of FIGS. 1-6 according to some implementations.

FIG. 11 is another example pictorial diagram of an area associated with a facility for positioning sensor systems of the facility management system of FIGS. 1-6 according to some implementations.

FIG. 12 is yet another example pictorial diagram of an area associated with a facility for positioning sensor systems of the facility management system of FIGS. 1-6 according to some implementations.

FIG. 13 is yet another example pictorial diagram of positions associated with a facility for positioning sensor systems of the facility management system of FIGS. 1-6 according to some implementations.

FIG. 14 is another example pictorial diagram of anomalies detectable by the facility management system of FIGS. 1-6 according to some implementations.

FIG. 15 is an example pictorial diagram of a heat map generated by the facility management system of FIGS. 1-6 according to some implementations.

### DETAILED DESCRIPTION

Discussed herein is a facility system for detecting anomalies, issues, and/or damage associated with operations of a transportation/logistic facility, vehicles collecting and delivering assets to and from the facility, and containers associated with the operations and transportation of the assets. In some examples, the sensor system may be positioned about the facility, such as on facility equipment (e.g., legs and/or implement of cranes, forklifts, autonomous aerial vehicles, and the like), on personnel (e.g., on helmets, vests and the like), or at fixed location (e.g., on buildings, specialized towers, and the like).

As discussed herein, the facility system may be vendor neutral and is daylight (e.g., time of day) and weather agnostics. In some cases, in order to detect anomalies, such as holes, warps, bumps, and the like in even extreme weather conditions (e.g., fog, rain, snow, or at extreme temperatures), the system may utilize data aggregated from and generated by multiple sensors of various types. For instance, the facility system may include a multi-layer solution which combines or aggregates data from different, vendor-agnostic data sources or sensors (e.g., LIDAR, SWIR, Radio Wave, and the like) together with image data.

In some cases, the system may apply a multi-level approach in which the first level includes collection of raw data via the different sensors and image devices. At a second level, and because there could be multiple vendors, formats, and the like involved for both sensor and video data, the facility system is configured to convert and/or transform the arriving data into a common information model that is vendor or third-party agnostic. In some cases, the common information model may be an industry specific schema, hierarchy, or machine learned model that is superset of forms, types, data arrangements, associated with each industry (e.g., international transit, local transit, rail-based transit, ship-based transit, food delivery, plastic good delivery, metal goods delivery, chemical delivery, electrical/computer components, and the like). for example, the common information model may be based on and specific to a combination of a method of delivery, a class or type of good, and/or a jurisdiction(s) of transit.

In this example, since the data received from different sensors may represent different ranges and data types, the third level may perform a data normalization where the facility system may apply techniques, such as threshold-based data normalization and the like. In the fourth level, the facility system may also apply machine learning models and networks to detect anomalies, issues, and/or damage, as discussed herein. At a fifth level, the facility system may also employ a weighted average of the output of detection probabilities from each individual data source. The value of weights from different devices, sensors, and/or video cameras, may differ under various and changing conditions including weather conditions, time of day (day versus night), and the like.

In some examples, the facility system may also utilize an accurate weather condition data feed (such as one or more third-party weather databases) to adjust the assigned weights in a dynamic and/or substantially real-time manner. In case of indoor operations in which the weather and light conditions are stable, the value of weights assigned to data from different devices may differ from sensors associated with outdoor operations. This allows the facility system to provide higher priority to output from sensor data which works better during certain weather conditions. For instance, as one illustrative example, in fog conditions, RADAR sensor data may be weighted higher than LIDAR. In some cases, the exact value of weights for a given weather condition are generated based on an output of one or more additional weather based machine learned models and/or networks. In some cases, these models and/or networks may be trained under different weather conditions and/or parameters.

In some examples, the facility system may be configured to assign repair and maintenance codes in an automated manner, for instance, based at least in part on the detected anomaly associated with the operation, vehicle, container, assets, or the like. The repair and maintenance codes often vary in the industry and the facility system may allow individual facilities the ability to configure and assign selected codes. In other cases, the system may assign codes based on predetermined factors, such as country of operations, type of anomaly, type of facility, equipment type or vehicle type, available personnel, facility capabilities, and the like.

In some cases, the sensors may be positioned either at fixed locations of the facility or via mobile autonomous systems, such as autonomous aerial vehicles (AAVs) and/or autonomous submersible vehicles (ASVs). For example, a sensor or device may include internet of things (IoT) computing devices and may be positioned about an entry and exit locations (e.g., check in and/or check out area), processing area, storage area, holding area, or the like of a storage facility, shipping yard, processing plant, warehouse, distribution center, port, rail yard, rail terminal, and the like. The IoT computing device may be equipped with various sensors and/or image capture technologies and configured to capture, parse, and identify vehicle and container information from the exterior of vehicles, containers, pallets, and the like.

As discussed above, the system may include multiple IoT devices as well as cloud-based services, such as cloud based data processing. As an illustrative example, the IoT computing devices may include a smart network video recorder (NVR) or other type of EDGE computing device. Each IoT device may also be equipped with sensors and/or image capture devices usable at night or during the day. The sensors may be weather agnostic (e.g., may operate in foggy, rainy, or snowy conditions), such as via infrared image systems, radar based image systems, LIDAR based image systems, SWIR based image systems, Muon based image systems, radio wave based image systems, and/or the like. The IoT computing devices and/or the cloud-based services may also be equipped with models and instructions to capture, parse, identify, and extract information from the vehicles, containers, and/or various documents associated with the logistics and shipping industry.

In some example, the IoT computing devices and/or the cloud-based facility system may be configured to perform segmentation, classification, attribute detection, recognition, document data extraction, and the like. In some cases, the IoT computing devices and/or an associated cloud based service may utilize machine learning and/or deep learning models to perform the various tasks and operations.

As described herein, the machine learned models may be generated using various machine learning techniques. For example, the models may be generated using one or more neural network(s). A neural network may be a biologically inspired algorithm or technique which passes input data (e.g., image and sensor data captured by the IoT (Internet of Things) computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters. As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

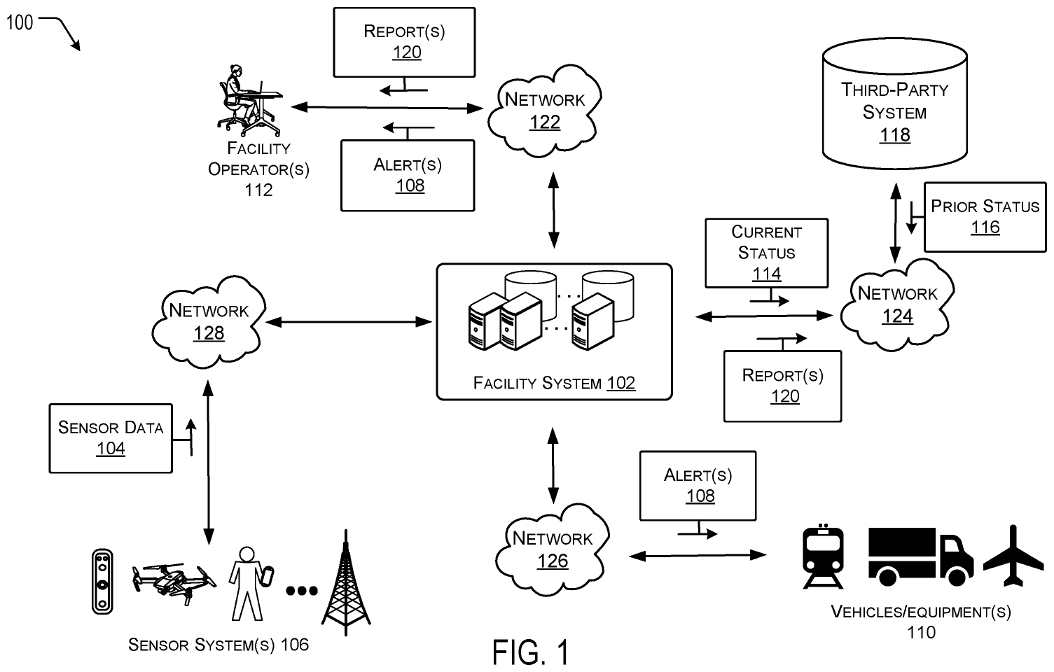

FIG. 1 is an example block diagram 100 of a facility system 102 for determining a status or condition of the transport, assessing damage, and detecting anomalies associated with the vehicle, equipment, and/or facility operations. In some cases, the facility system 102 may be configured to receive sensor data 104 from sensor systems 106 associated with a facility. In some cases, the sensor systems 106 may be fixed at locations associated with the facility such as a gate, runway, dock, rail depot, loading/unloading area, and the like. In other cases, the sensor systems 106 may be fixed on towers or associated with AAVs, as discussed herein. In some cases, the sensor system 106 may be handheld or associated with a downloadable application on a handheld electronic device, such as a smart phone, tablet, or the like. In these cases, a user may scan the transport, container, or asset using the electronic device and the associated downloadable application.

In some cases, the sensor system 106 may include image devices, recording and data storage devices or systems, and the like. During operations, the sensors 106 may collect data along with the image or video, and the like. The image or video data may be sent to a cloud-based service over a wireless interface (such as streaming data) such as the facility system 102. In some cases, the sensor data 104 may include image data associated with a field of view of the sensor 106.

In some cases, the facility system 102 may determine an identity of a transport or vehicle based at least in part on one or more identifier(s) within the sensor data 104, segmented, classified, and/or identified features of the vehicles, or the like. For example, the facility system 102 may locate and track identifiers (such as license numbers) on the vehicle or container. Upon identification, the facility system 102 may access stored prior status associated with the identified vehicle or container to assist with assessing anomalies, issues, and/or damage.

Additionally, the facility system 102 may analyze the sensor data 104 to determine a status of the vehicle, container, operation, or the like. For example, the system 102 may determine if the vehicle is damaged, in need of repair operations, if an operation should be halted (e.g., a dangerous situation is present), or the like. As discussed above, the facility system 102 may be configured to apply a multi-level approach to detecting anomalies, issues, damage, and the like associated with operations of a facility. In these examples, the system 102 may apply a first level which includes collection of raw data via the different sensors and image devices, generally indicated as sensor systems 106. At a second level the sensor data 104 may be processed by the facility system 102 to convert the sensor data 104 into a common information model that is vendor or third-party agnostic.

In this example, since the sensor data 104 received from different sensor systems 104 may represent different ranges and data types, the third level implemented by the facility system 102 may be a data normalization. The data normalization process may include applying techniques, such as threshold-based data normalization and the like, to the sensor data 104. In the fourth level, the facility system 102 may apply machine learning models and networks to detect anomalies, issues, and/or damage, as discussed herein. In one example, the facility system 102 may utilize the machine learned models and/or networks to detect damage, unsafe operations, and the like. For instance, in some cases, during hoisting of chassis during unloading of containers (e.g., off/on a ship, train, trailer, or truck) the facility system may experience an anomaly, such as the track or trailer remaining coupled to the container, the container at least partially decupling from the implement of the crane, or the like. In this example, the facility system 102 using the sensor data 104 and the machine learned model may detect the separation of the implement from the container and/or the vehicle from the ground. In the illustrated example, the system 102 may be configured to, in response to detecting the anomaly, send a signal, such as alert 108, to, for example, vehicles/equipment 110 (e.g., the crane), facility operators 112 (e.g., crane operators, drivers, and the like) to halt operations, thereby preventing injury, further damage, and the like to assets, equipment 110, and personnel 112.

At a fifth level, the facility system 102 may also employ a weighted average of the output of detection probabilities from each individual data source. The value of weights from different sensor systems 104 may differ under various and changing conditions including weather conditions, time of day (day versus night), and the like. The values of the weights may then be utilized to select between the sensor systems 104 for providing input into the machine learned models and/or networks to detect the anomalies and generate the alerts 108.

In the current example, the system 102 may also determine a current status 114 of the vehicle, equipment, container, operation, or the like based at least in part on the sensor data 104. In some cases, the facility system 102 may also receive a prior status 116 of the vehicle, equipment, container, operation, or the like from a third-party system 118 (e.g., a prior facility, owner of the vehicle or assets, a regulatory body, and the like). The system 102 may then, in some cases, utilize the prior status 116 together with the currently determined status 114 to detect anomalies, such as damage that may have occurred during transit or via an operation at the facility.

In some cases, if one or more anomalies are detected, the facility system 102 may generate a report 120 which may be provided to a facility operators 112 as well as to one or more third-party systems 118. For example, the facility system 102 may provide a report to a repair facility, a governmental body, an owner of the involved equipment/assets, and the like. The reports 120 may include status (such as damage), suggestions to reduce issues and anomalies in the future, maintenance operations, a rating (such as red, yellow, green) associated with the readiness of the facility and/or vehicle, suggested manual follow up, estimates to damages or costs, or the like. In one specific example, the report 120 may include a determination of liability for and/or cause of the anomalies.

In the current example, the sensor data 104, alerts 108, statuses 114 and 116, and reports 118 may be sent and/or received by the facility system 102 via various networks, such as networks 122-128. In some case, the networks 122-128 may be different networks, while in other cases the networks 122-128 may be the same.

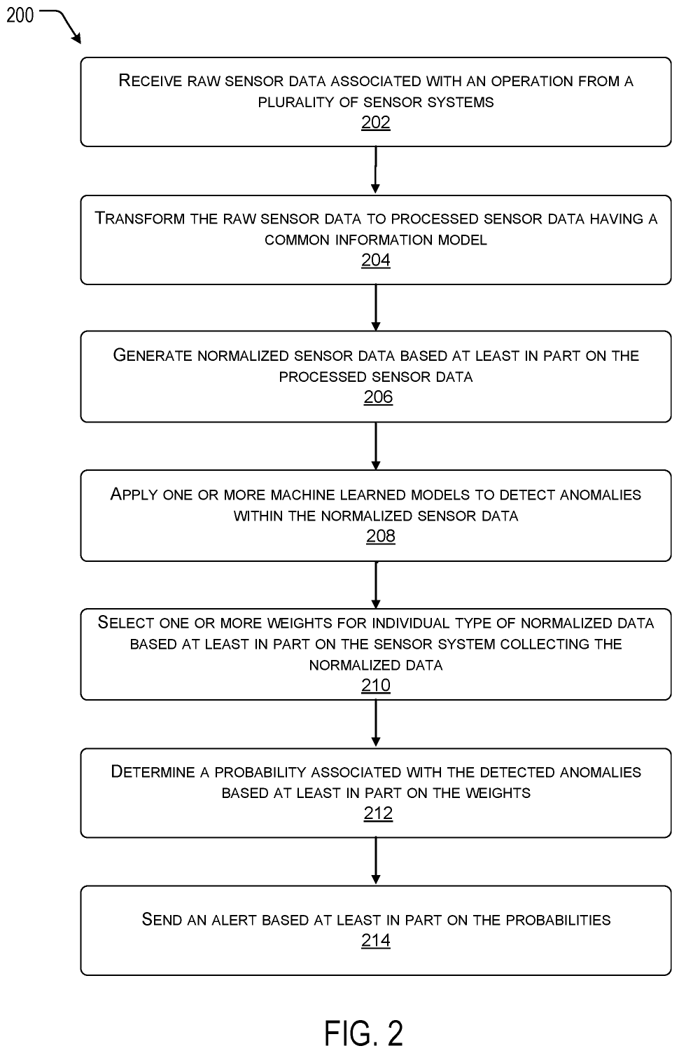

FIGS. 2-4 are flow diagrams illustrating example processes associated with the monitoring operation associated with a facility system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 is a flow diagram illustrating an example process associated with monitoring facility operations according to some implementations. As discussed above, a facility may be configured to monitor operations, vehicles, equipment, assets and the like via a facility system that includes multiple sensors of various types positioned through the facility.

At 202, the facility system may receive raw sensor data associated with an operation from a plurality of sensor systems. In some cases, the sensor systems may be of various types and positioned at various locations about the facility. For example, the sensor systems may include LIDAR, SWIR, Radio Wave, red-green-blue image devices (e.g., videos and cameras), thermal imaging devices, and the like. In some cases, the sensors may be IoT, EDGE, or NVR based sensors.

At 204, the facility system may transform the raw sensor data to processed sensor data having a common information model. For example, the sensor data from the different types of sensors may be converted to a single format that is vendor/type agnostic. In other examples, the system may use sensor data (such as image data) from two different sensors which output data at different resolutions and use one or more transformations (such as one or more scale operation, translation operation, rotation operations, and/or the like) to bring them on a common scale. Another example is we can use Voxel data generated by Lidars etc. and then using algorithms attribute it to the pixels of an image taken from a camera. This is called sensor fusion.

At 206, the facility system may generate normalized sensor data based at least in part on the processed sensor data. For example, the sensor data may be from ranges, fields of view, and/or of different types. In these cases, the facility system may perform a data normalization where the facility system may apply techniques, such as threshold-based data normalization and the like to the sensor data to align the ranges, fields of view, and the like.

At 208, the facility system may apply one or more machine learned models to detect anomalies within the normalized sensor data. For instance, the facility system may input the normalized sensor data into one or more machine learned models trained to detect damage to vehicles or equipment, unsafe operations, and the like.

At 210, the facility system may select one or more weights for individual types of normalized data based at least in part on the sensor system collecting the normalized data. For example, the system may increase a value of a thermal sensor or SWIR sensor during rain or fog while decreasing the value of the weight applied to the image sensor and/or RADAR sensor. For example, the system may initialize the weights with predetermined defaults based at least in part on similar use cases and/or historical data. It should be understood that the predetermined defaults may be adjusted in substantially real-time as the data is processed by the facility system.

At 212, the facility system may determine a probability associated with the detected anomalies based at least in part on the weights. For example, if the weather is foggy and the anomalies are detected within the image data, the system may discard the anomalies as the probability may be low that the anomalies exist. However, if the anomalies are in the SWIR data and the weather is foggy, then the system may proceed to 214 and send an alert based at least in part on the probabilities. For example, the alert may include instructions or signals to cause equipment to halt an operator or personnel to halt an operation or the like.

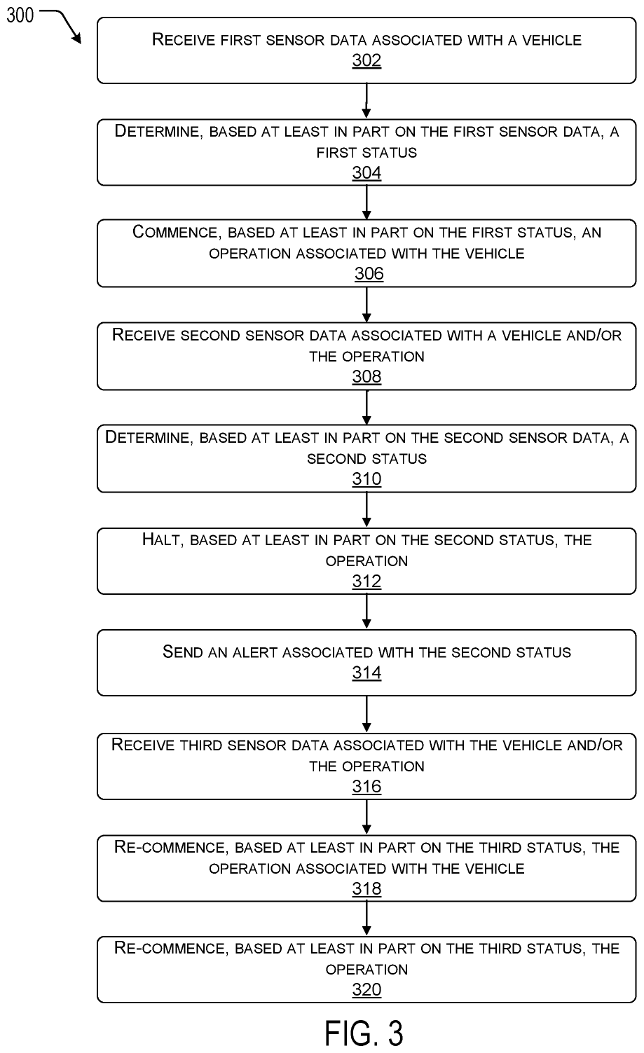

FIG. 3 is a flow diagram illustrating an example process associated with monitoring facility operations according to some implementations. As discussed above, a facility may be configured to monitor operations, vehicles, equipment, assets and the like via a facility system that includes multiple sensors of various types positioned through the facility.

At 302, the facility system may receive first sensor data associated with a vehicle. For example, the vehicle may be involved with an operation, approaching a gate or entry, exiting the facility, or the like. The sensor data may include data associated with an exterior of the vehicle, an exterior of a chassis coupled to the vehicle, an exterior one or more containers associated with the vehicle, as well as sensor data associated with displayed documentation (such as paperwork displayed via one or more of the window of the vehicle), an interior or content of the containers or vehicle, and the like. In some cases, the sensor data may include LIDAR data, SWIR data, red-green-blue image data, thermal data, Muon data, radio wave data, weight data, infrared data, and the like.

At 304, the facility system may determine, based at least in part on the first sensor data, a first status. For example, the first status may be operational, requires inspection, and/or maintenance required. In some cases, the status may include characteristics associated with the vehicle or container, such as potential damage, rust, low tires, frayed lines, leaking fluids, and/or the like.

At 306, the facility system may cause an operation associated with the vehicle to commence based at least in part on the first status. For example, the facility system may approve or commence an unload or load operation.

At 308, the facility system may receive second sensor data associated with a vehicle and/or the operation. The second sensor data may again be a status associated with the vehicle and/or a status of the operation, such as safe or unsafe. In some cases, the second data may have a different type then the first data. For instance, the first data may be image data and the second data may be RADAR data.

At 310, the facility system may determine, based at least in part on the second sensor data, a second status. For example, the second status may be associated with a vehicle, such as operational, requires inspection, and/or maintenance required, and/or a status of the operation, such as safe or unsafe. In some cases, the second status may include characteristics associated with the operation, personnel, vehicle, and/or container, such as potential damage, rust, low tires, frayed lines, leaking fluids, and/or the like.

At 312, the facility system may halt, based at least in part on the second status, the operation, such as an operation associated with the vehicle (e.g., loading or unloading). For example, the first sensor data may represent an operation at a first time and the second sensor data may represent the operation at a second time after the first time. In this example, between the first time and the second time, the operation may have become unsafe or other conditions may have changed causing the facility system to halt the operation.

At 314, the facility system may send an alert associated with the second status. For example, the alert may be provided to a third-party, personnel associated with the facility, or the like. For example, the alert may inform the personnel at the facility as to why the halt was ordered and/or instructions or data usable to correct the detected anomaly causing the halt.

At 316, the facility system may receive third sensor data associated with the vehicle and/or the operation. The third sensor data may again be associated with the vehicle involved with the operation or again a status of a personnel or condition associated with the operation. In some cases, the third sensor data may represent the operation at a third time after the second time.

At 318, the facility system may determine, based at least in part on the third sensor data, a third status. For example, third status may also be operational, requires inspection, and/or maintenance required.

At 320, the facility system may re-commence, based at least in part on the third status, the operation. For instance, at the third time, the personnel at the facility may have correct the anomaly or the conditions may have returned within a safety threshold, or the like.

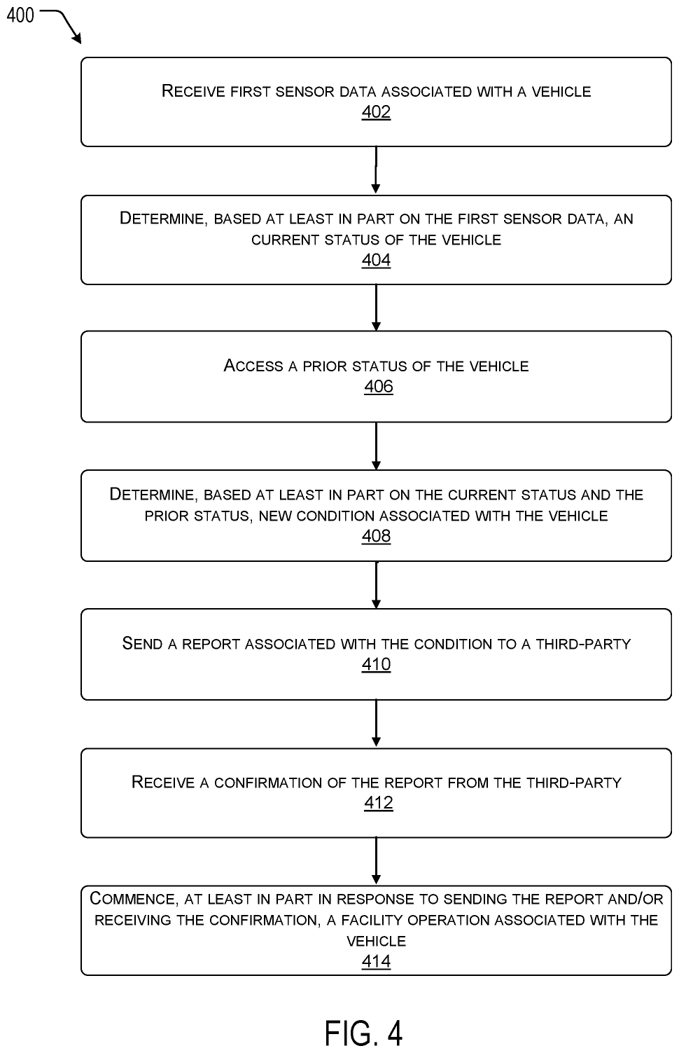

FIG. 4 is a flow diagram illustrating an example process associated with assessing transport vehicles according to some implementations. As discussed above, a facility may be configured to monitor operations, vehicles, equipment, assets and the like via a facility system that includes multiple sensors of various types positioned through the facility.

At 402, the facility system the facility system may receive first sensor data associated with a vehicle. For example, the vehicle may be involved with an operation, approaching a gate or entry, exiting the facility, or the like. The sensor data may include data associated with an exterior of the vehicle, an exterior of a chassis coupled to the vehicle, an exterior one or more containers associated with the vehicle, as well as sensor data associated with displayed documentation (such as paperwork displayed via one or more of the window of the vehicle), an interior or content of the containers or vehicle, and the like. In some cases, the sensor data may include LIDAR data, SWIR data, red-green-blue image data, thermal data, Muon data, radio wave data, weight data, infrared data, and the like.

At 404, the facility system may determine, based at least in part on the first sensor data, a current status of the vehicle. For example, the first status may be operational, requires inspection, and/or maintenance required. In some cases, the status may include characteristics associated with the vehicle or container, such as potential damage, rust, low tires, frayed lines, leaking fluids, and/or the like.

At 406, the facility system may access a prior status of the vehicle. For example, the systems may access a maintenance and repair system or database and/or receive a status report from a prior facility (such as the origins of the arriving assets).

At 408, the facility system may determine, based at least in part on the current status and the prior status, new condition associated with the vehicle. For example, the new condition may include damage, wear and tear (e.g., tire tread states), missing components, change in weight (e.g., based on tire to chassis separation or the like), and the like.

At 410, the facility system may send a report associated with the condition to a third-party. For example, the system may send a report to an owner of the vehicle, the seller of the assets, the purchaser of the assets, a governmental body, or the like.

At 412, the facility system may receive a confirmation of the report from the third-party. In some cases, the confirmation may include instructions to proceed with a scheduled operation. In other cases, the confirmation may request maintenance and repairs be performed, while in still other cases, the confirmation may request a change in the scheduled operations based at least in part on the report. In some instances, when a change is requested, the third-party may authorize payment for the change as part of the confirmation. For example, the third-party may request manual unloading, manual or additional inspections of the vehicle, assets, or the like, and the confirmation may authorize payment for the additional operations.

At 414, the facility system may commence, at least in part in response to sending the report and/or receiving the confirmation, a facility operation associated with the vehicle. For example, the operation may include unloading and/or loading of the vehicle.

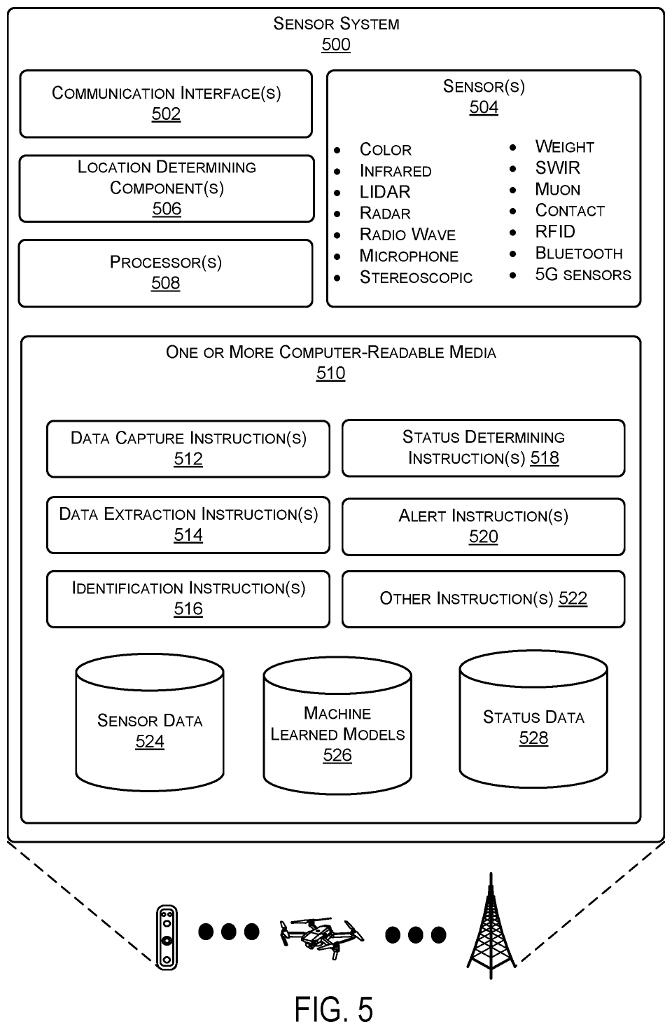

FIG. 5 is an example sensor system 500 that may implement the techniques described herein according to some implementations. For example, the sensor system 500 may be a fixed mounted system, such as an EDGE computing device or incorporated into an AAV, as discussed above.

In some implementations, the sensor system 500 may include one or more communication interface(s) 502 that enables communication between the sensor system 500 and one or more other local or remote computing device(s) or remote services, such as a facility system of FIGS. 1-4. For instance, the communication interface(s) 502 can facilitate communication with other proximity sensor systems, a central control system, or other facility systems. The communications interfaces(s) 502 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more sensor(s) 504 may be configured to capture the sensor data 524 associated with assets. In at least some examples, the sensor(s) 504 may include thermal sensors, time-of-flight sensors, location sensors, LIDAR sensors, SWIR sensors, radar sensors, sonar sensors, infrared sensors, cameras (e.g., RGB, IR, intensity, depth, etc.), Muon sensors, microphone sensors, environmental sensors (e.g., temperature sensors, humidity sensors, light sensors, pressure sensors, etc.), and the like. In some examples, the sensor(s) 504 may include multiple instances of each type of sensor. For instance, camera sensors may include multiple cameras disposed at various locations.

The sensor system 500 may also include one or more location determining component(s) 506 for determining a global position of the sensor or a vehicle associated with the sensor, such as for use in navigation. The location determining component(s) 506 may include one or more sensor package combination(s) including Global Navigation Satellite System (GNSS) sensors and receivers, Global Positioning System (GPS) sensors and receivers, or other satellite systems. For example, the location determining component(s) 506 may be configured to decode satellite signals in various formats or standards, such as GPS, GLONASS, Galileo or BeiDou. In some cases, the location determining component(s) 506 may be placed at various places associated with the assets, THU, and/or transports to improve the accuracy of the coordinates determined from the data received by each of the location determining component(s) 506.

The sensor system 500 may include one or more processor(s) 508 and one or more computer-readable media 510. Each of the processors 508 may itself comprise one or more processor(s) or processing core(s). The computer-readable media 510 is illustrated as including memory/storage. The computer-readable media 510 may include volatile media (such as random access memory (RAM)) and/or nonvolatile media (such as read only memory (ROM), Flash memory, optical disks, magnetic disks, and so forth). The computer-readable media 810 may include fixed media (e.g., GPU, NPU, RAM, ROM, a fixed hard drive, and so on) as well as removable media (e.g., Flash memory, a removable hard drive, an optical disc, and so forth). The computer-readable media 510 may be configured in a variety of other ways as further described below.

Several modules such as instructions, data stores, and so forth may be stored within the computer-readable media 510 and configured to execute on the processors 508. For example, as illustrated, the computer-readable media 510 stores data capture instructions 512, data extraction instructions 514, identification instructions 516, status determining instructions 518, alert instructions 520, as well as other instructions 522, such as an operating system. The computer-readable media 510 may also be configured to store data, such as sensor data 524 and machine learned models 526, and log data 528 as well as other data.

The data capture instructions 512 may be configured to utilize or activate the sensor systems 504 to capture sensor data 524 associated with a transport vehicle. The captured sensor data 524 may then be stored and/or transmitted or streamed to the facility system, as discussed herein.

The data extraction instructions 514 may be configured to extract, segment, classify objects represented within the sensor data 524. For example, the data extraction instructions 514 may segment and classify features (such as components) of the transport vehicle as well as other characteristics (such as damage and the like). In some cases, the data extraction instructions 514 may utilize the machine learned models 526 to perform extraction, segmentation, classification, and the like. In these examples, the data extraction may be performed prior to streaming the sensor data 504 to the facility system.

The identification instructions 516 may be configured to determine an identity of a vehicle, personnel, asset, or the like. For example, the identification instructions 516 may utilize one or more machine learned model(s) 526 with respect to the sensor data 524 and/or the extracted data to determine the identity of a transport vehicle, as discussed above. In these examples, the identification may be performed prior to streaming the sensor data 504 to the facility system.

The status determining instructions 518 may be configured to process the sensor data 524 to detect anomalies associated with the operation. For example, the status determining instructions 518 may detect anomalies using the machine learned models 526 trained on sensor data associated with successful and erroneous past operations as well as using synthetic training data. In some cases, the status determining instructions 518 may also rate or quantify any anomalies using a severity rating and/or value. In these examples, the status may be determined prior to streaming the sensor data 504 to the facility system.

The alert instructions 520 may be configured to alert or otherwise notify personnel or systems (such as autonomous systems or vehicles) as to any of the damage, issues and/or concerns detected by the sensor system 500. In some cases, the alert instructions 520 may order operations to be performed. In other cases, the alert instructions 520 may provide reports or updates related to the operations.

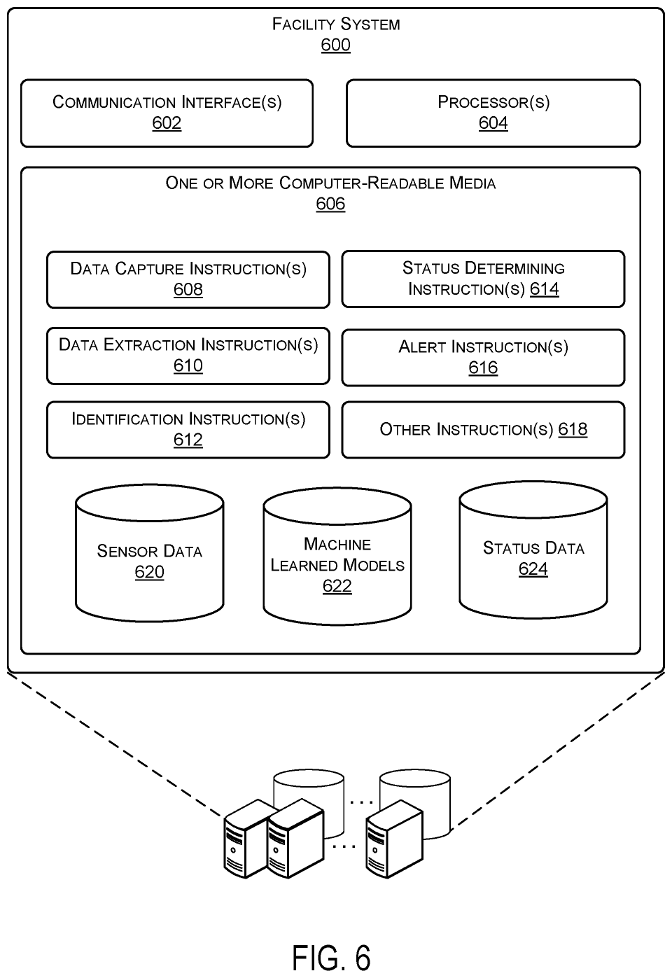

FIG. 6 is an example facility system 600 that may implement the techniques described herein according to some implementations. The facility system 600 may include one or more communication interface(s) 602 (also referred to as communication devices and/or modems). The one or more communication interfaces(s) 602 may enable communication between the system 600 and one or more other local or remote computing device(s) or remote services, such as sensors system of FIG. 5. For instance, the communication interface(s) 602 can facilitate communication with other proximity sensor systems, a central control system, or other facility systems. The communications interfaces(s) 602 may enable Wi-Fi-based communication such as via frequencies defined by the IEEE 802.11 standards, short range wireless frequencies such as Bluetooth, cellular communication (e.g., 2G, 3G, 4G, 4G LTE, 6G, etc.), satellite communication, dedicated short-range communications (DSRC), or any suitable wired or wireless communications protocol that enables the respective computing device to interface with the other computing device(s).

The facility system 600 may include one or more processor(s) 604 and one or more computer-readable media 606. Each of the processors 604 may itself comprise one or more processors or processing cores. The computer-readable media 606 is illustrated as including memory/storage. The computer-readable media 606 may include volatile media (such as random access memory (RAM)) and/or nonvolatile media (such as read only memory (ROM), Flash memory, optical disks, magnetic disks, and so forth). The computer-readable media 606 may include fixed media (e.g., GPU, NPU, RAM, ROM, a fixed hard drive, and so on) as well as removable media (e.g., Flash memory, a removable hard drive, an optical disc, and so forth). The computer-readable media 606 may be configured in a variety of other ways as further described below.

Several modules such as instructions, data stores, and so forth may be stored within the computer-readable media 606 and configured to execute on the processors 604. For example, as illustrated, the computer-readable media 606 stores data capture instruction 608, data extraction instructions 610, identification instructions 612, status determining instructions 614, alert instructions 616, as well as other instructions 618, such as an operating system. The computer-readable media 606 may also be configured to store data, such as sensor data 620 and machine learned models 622, and log data 624 as well as other data.

The capture instruction 608 may be configured to select sensor systems, such as one or more available sensor system 504, to capture sensor data 620 associated with an operation, vehicle, personnel, facility equipment and the like. In some cases, the capture instructions 608 may cause the facility system 600 to select the sensor systems based on sensor types, weather conditions, type of operation, type of vehicle or equipment involved in the operations, and the like. In one specific example, the capture instruction 608 may score the sensor system by applying a weighted average of the output of detection probabilities from each individual sensor system. The value of weights from different devices, sensors, and/or video cameras, may differ under various and changing conditions including weather conditions, time of day (day versus night), and the like. In this manner, the capture instructions 608 may include a selection of image sensors during a sunny day and RADAR sensors at night. In other situations, the selection may include SWIR sensors during foggy condition or the like.

The data extraction instructions 610 may be configured to extract, segment, classify objects represented within the sensor data 620. For example, the data extraction instructions 610 may segment and classify features (such as components) of the transport vehicle as well as other characteristics (such as damage and the like). In some cases, the data extraction instructions 610 may utilize the machine learned models 620 to perform extraction, segmentation, classification, and the like.

In one specific example, the data extraction instructions 610 may apply a multi-level approach. The multi-level approach may include converting and/or transforming the sensor data 620 arriving (e.g., streamed) from multiple different sensor systems into a common information model that is vendor or third-party agnostic. Next, the data extraction instructions 610 may perform a data normalization where the facility system may apply techniques, such as threshold-based data normalization and the like, to align the ranges and/or views of the sensor systems represented by the various sensor data 620.

The identification instructions 612 may be configured to determine an identity of the vehicle, assets, operation, personnel, equipment, and/or the like. For example, the identification instructions 612 may utilize one or more machine learned model(s) 622 with respect to the sensor data 620 (e.g., the normalized data) to determine the identity, as discussed above.

The status determining instructions 614 may be configured to process the sensor data 620 (e.g., the normalized data) to identify anomalies, such as damage, issues, and/or concerns associated with an operation. For example, the status determining instructions 614 may detect damage to a vehicle using the machine learned models 622. In some cases, the status determining instructions 612 may also rate or quantify any anomalies, for instance, using a severity rating and/or value. For example, the rating may include applying a weighted average of the output of detection probabilities from each individual data source. The value of weights from different devices, sensors, and/or video cameras, may differ under various and changing conditions including weather conditions, time of day (day versus night), and the like.

The alert instructions 616 may be configured to alert or otherwise notify personnel or systems (such as autonomous systems—cranes, forklifts, and the like) as to any detected anomalies. For instance, the alert may include a halt instruction when, for example, the rating determined by the status determining instructions 614 is greater than or equal to a danger threshold. In some cases, the halt instructions may be directed to autonomous or semi-autonomous vehicles/equipment (e.g., transports, forklifts, cranes, and the like) while in other cases the halt instructions may be sent to facility personnel.

The alert instructions 616 may also provide reports to third-parties related to the assets and/or operations associated with their assets, the facility operators, transport companies, and the like.

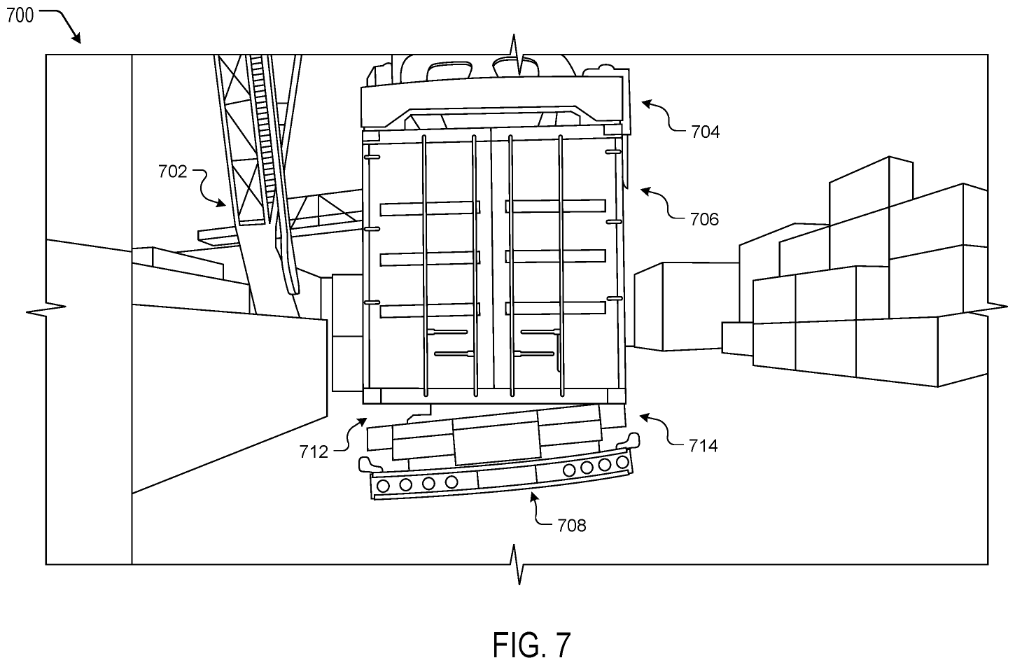

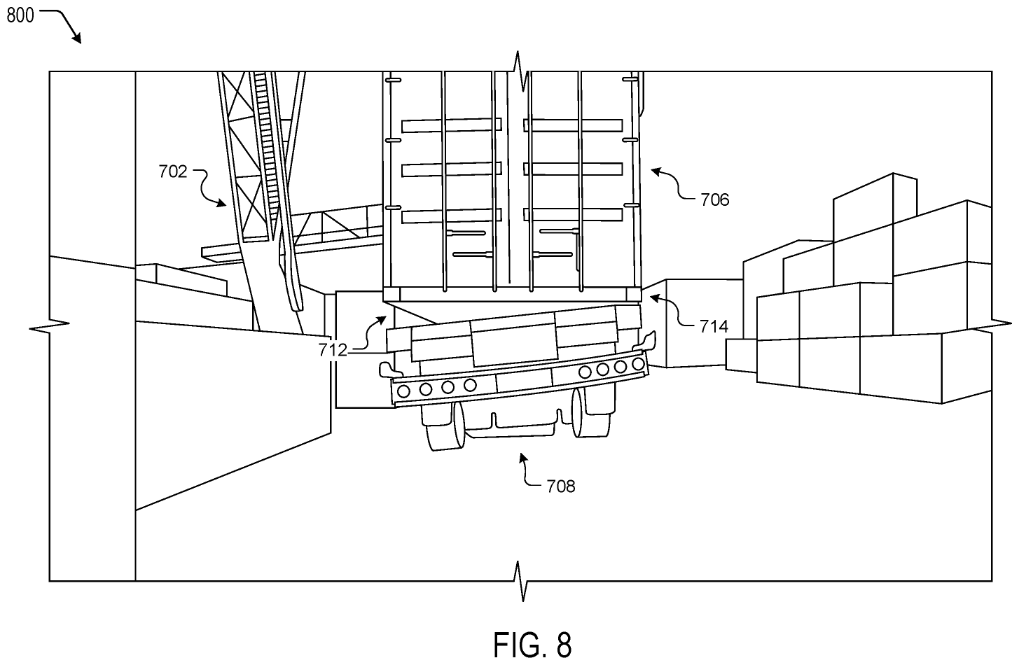

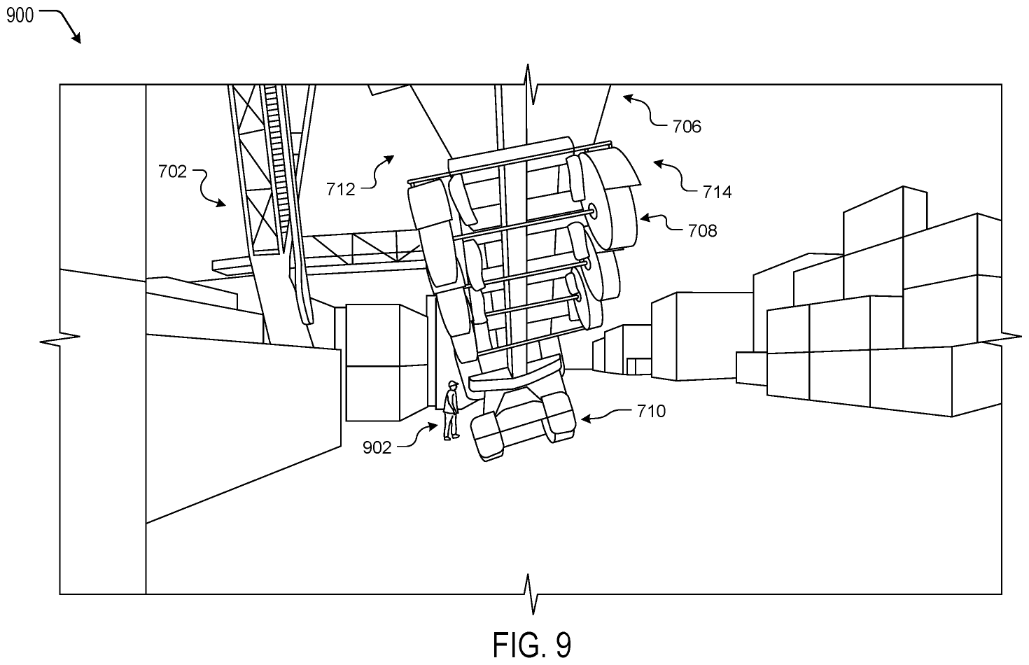

FIGS. 7-9 are example pictorial diagrams 700-900 of a potential anomalies associated with a facility detectable by the facility management system of FIGS. 1-6 according to some implementations. In the illustrated examples, a crane 702 may be coupling an implement 704 (such as a claw) to a container 706 positioned on a chassis 708 of a transport vehicle 710. In this example, a left side 712 of the chassis 708 has been decoupled from the container 706. However, the right side 714 of the chassis 708 has not been decoupled from the container 706 as illustrated. In this example, the facility system, discussed herein, may capture sensor data associated with the operation (e.g., the removal of the container 706 from the chassis 708), detect within the sensor data that the gap between the container 706 and the chassis 708 on the left side 712 is not substantially similar (e.g., within a threshold distance) to a gap in the right side 714. The facility system may also detect a lack of a gap or separation on the right side 714. In still other examples, the chassis 708 may position on a weight sensor or contact sensor, such that the sensor data registers the right side 714 being lifted from the ground. As illustrated with respect to FIGS. 8 and 9, as the crane 702 retracts the implement 704, the chassis 708 and/or the vehicle 710 may be lifted from the ground creating a risk of injury as the coupling breaks (e.g., the coupling is not design for lifting of the chassis 708) and the chassis crashes to the ground.

As discussed herein, the facility system may include sensors associated with the crane 702 (e.g., along the bottom), the implement 704, the ground, associated with other equipment, on the vehicle, associated with personnel, such as personnel 902 in FIG. 9, or at other positions. These sensor systems may stream or otherwise provide sensor data (e.g., either processed or unprocessed) to the facility system that may aggregate the sensor data and analyze the aggregated data to determine the presence of the anomaly or unsafe condition, as shown.

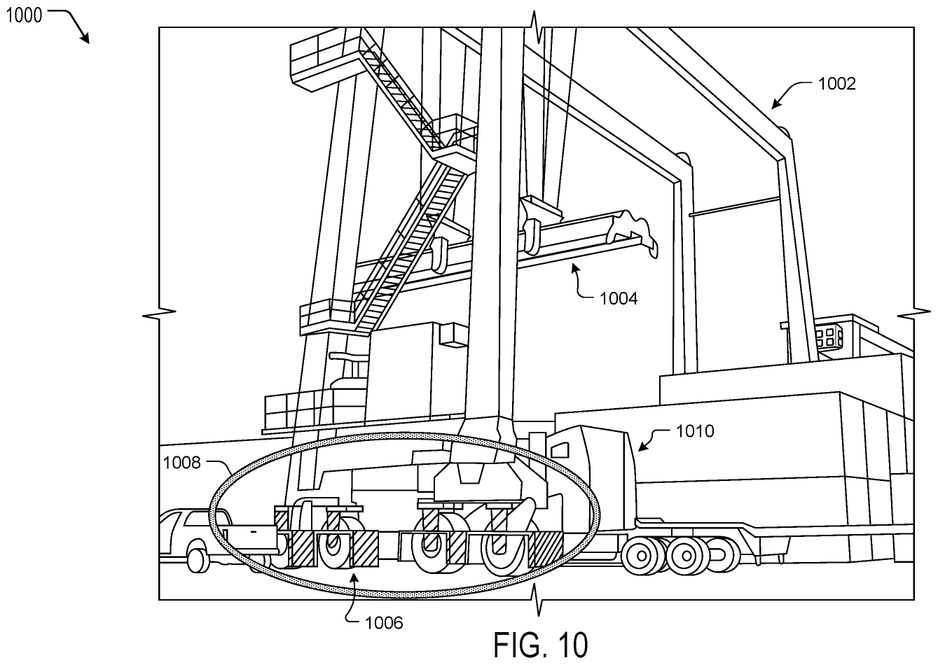

FIG. 10 is an example pictorial diagram 1000 of an area 1008 associated with a facility for positioning sensor systems of the facility management system of FIGS. 1-6 according to some implementations. As illustrated herein, a crane 1002 including an implement 1004 and a movable outrigger or base 1006. In this example, the sensor systems may be positioned in the area 1008 about the movable outrigger or base 1006, such that the sensor systems may align with the vehicle 1010 as the movable outrigger or base 1006 aligns with the vehicle 1010. In this manner, the sensor systems may have a field of view of the operation that is properly aligned without requiring additional moveable components or self-alignment systems. In some cases, the area 1008 may be equipped with multiple types and ranges of sensors systems, such as location or satellite position based sensor systems, RADAR, LIDAR, SWIR, thermal, image based, proximity, and the like.

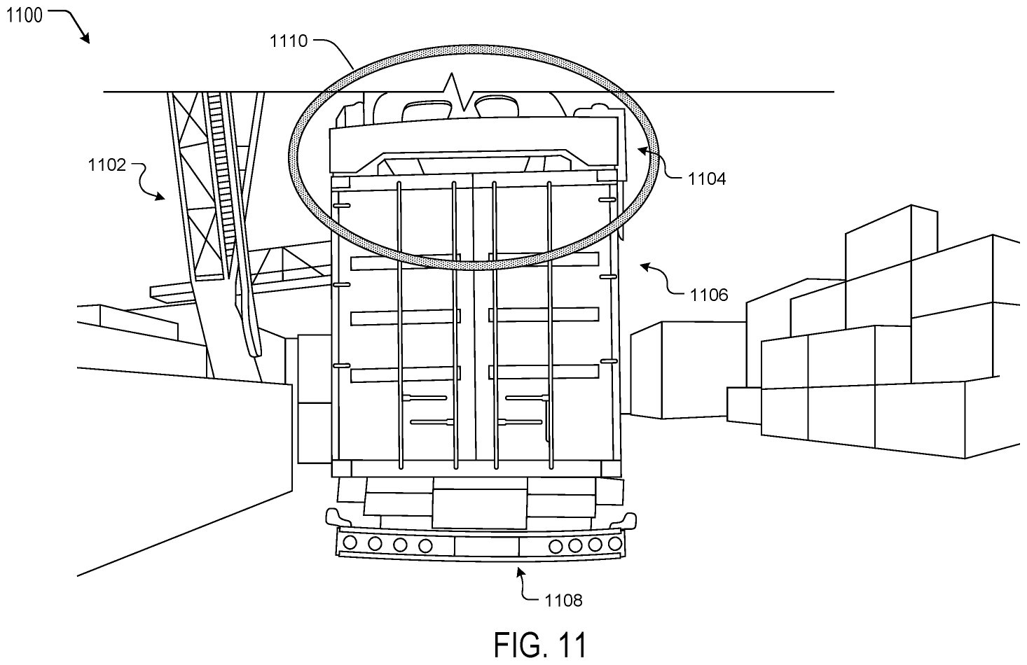

FIG. 11 is another example pictorial diagram 1100 of an area 1110 associated with a facility for positioning sensor systems of the facility management system of FIGS. 1-6 according to some implementations. In the illustrated example, a crane 1102 is shown coupling an implement 1104 (such as a claw) to a container 1106 positioned on a chassis 1108. In this example, the sensor systems may be positioned in the area 1110 about the implement 1104, such that the sensor systems may align with the container 1106 as the implement 1104 aligns with the container 1106. In this manner, the sensor systems may have a field of view of the operation that is properly aligned without requiring additional moveable components or self-alignment systems. In some cases, the area 1110 may be equipped with multiple types and ranges of sensors systems, such as location or satellite position based sensor systems, RADAR, LIDAR, SWIR, thermal, image based, proximity, and the like.

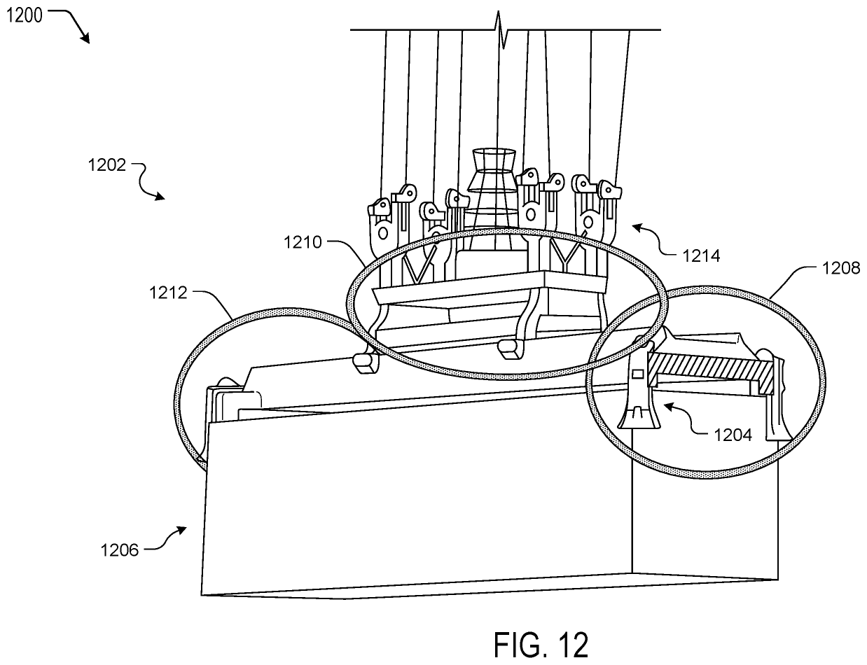

FIG. 12 is yet another example pictorial diagram 1200 of areas associated with a facility for positioning sensor systems of the facility management system of FIGS. 1-6 according to some implementations. In the illustrated example, a crane 1202 is shown with an implement 1204 (such as a claw) coupled to a container 1206. In this example, the sensor systems may be positioned in the areas 1208-1212 about the implement 1204, such that the sensor systems may align with the container 1206 as the implement 1204 aligns with the container 1206. In this manner, the sensor systems may have a field of view of the operation that is properly aligned without requiring additional moveable components or self-alignment systems. In this example, the area 1208 and 1212 may be associated with the front and back end of the implement 1204 while the area 1210 may be associated with the lift mechanism 1214. In this manner, the sensors systems associated with areas 1208 and 1212 may monitor the coupling between the container 1206 and the implement 1204 as well as the doors, locks, and other areas of the container 1206. Likewise, the sensor systems associated with the area 1212 of the lift mechanism 1214 may monitor the operations of the crane 1202, such as the cables, gears, pulleys, and the like.

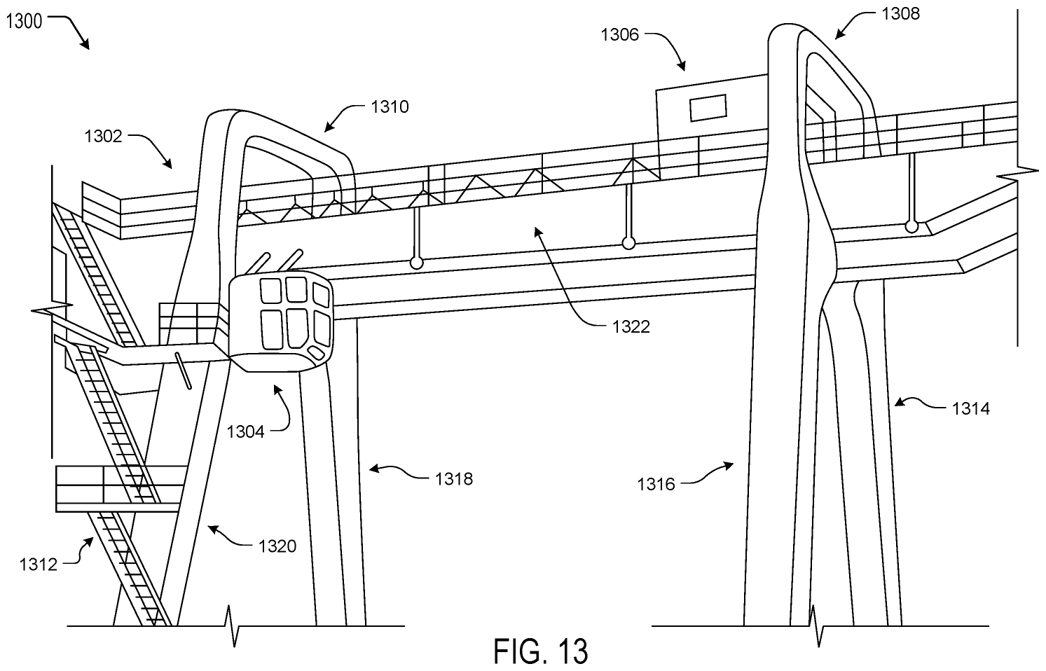

FIG. 13 is yet another example pictorial diagram 1300 of positions 1304 associated with a facility for positioning sensor systems of the facility management system of FIGS. 1-6 according to some implementations. In the current example, the top portion of a crane 1302 is illustrated. In this example, the sensor systems may be positioned with respect to the main control cabin 1304, the trolley 1306, either of the saddles 1308 or 1310, the ladder 1312, along the support legs 1314-1320, or along the main line 1322, and the like.

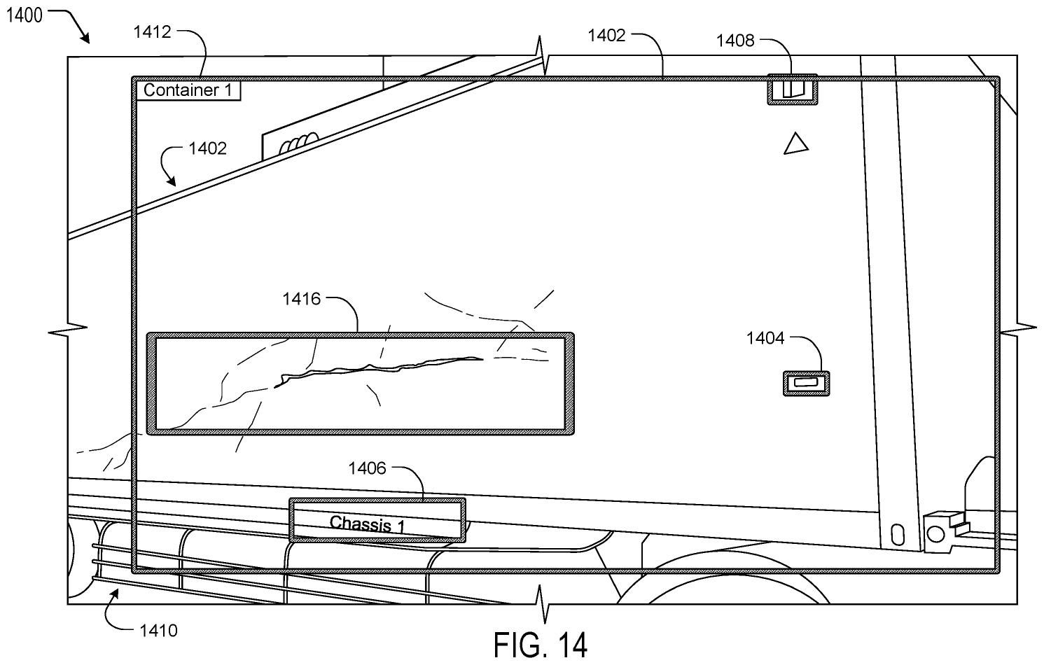

FIG. 14 is another example pictorial diagram 1400 of anomalies detectable by the facility management system of FIGS. 1-6 according to some implementations. In this example, the facility system may receive sensor data associated with the side of a container 1402. The system may process the sensor data to both detect identifiers, such as 1404-1408, that may be associated with the container 1402, the chassis 1410, the vehicle, and/or the like. In the current example, the facility system may designate a bounding box 1412 associated with the container 1402 based on the sensor data. The facility system has also extracted and assigned the container an identifier 1414 based on the detected identifiers 1404 and 1408.

In this example, the container 1402 has existing damage 1416 that the facility system detected via the sensor data, as shown. In this example, the facility system may rate or quantify the damage 1416 and determine if operations (e.g., repairs, inspections, or the like) are required or advisable prior to performing unloading and/or loading operations. In some examples, the facility system may provide instructions to the vehicle (e.g., an autonomous vehicle) or to a driver of the vehicle to proceed to a repair or inspection area of the facility instead of to an unloading or loading area. In this manner, the facility system may improve the operations of the facility as the vehicle does not queue or consume time in the loading/unloading areas or zones until the container 1402 is ready to be lifted from the chassis 1410.

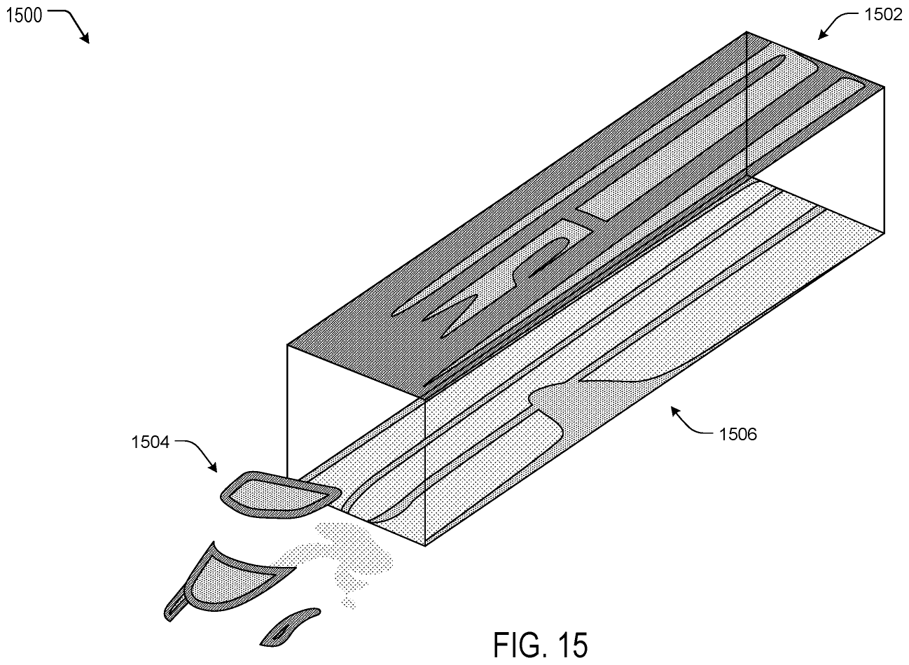

FIG. 15 is an example pictorial diagram 1500 of a sensor data 1502 generated by the facility management system of FIGS. 1-6 according to some implementations. In this example, a vehicle 1504, a container 1506, and/or the like may be represented in sensor data 1502 as a heat map or other type of image that is weather agnostic. Accordingly, the facility system may operate in various weather conditions.

### Example Clauses

A. A method comprising: receiving first sensor data associated with an operation at a facility; receiving second sensor data associated with the operation at the facility; transforming, based at least in part on a common model, the first sensor data and the second sensor data into first processed sensor data and second processed data; generating normalized sensor data based at least in part on the first sensor data and the second sensor data; detecting, based at least in part on the normalized data, at least one anomaly associated with the operation; determining a probability associated with the at least one anomaly; and sending, based at least in part on the probability, an alert to a system associated with the operation.
B. The method of A, wherein the second sensor data has a different modality than the first sensor data.
C. The method of A or B, wherein generating the normalized sensor data is based at least in part on threshold-based data normalization.
D. The method any of A-C, wherein detecting the at least one anomaly further comprises: inputting the normalized data into one or more machine learned model or network trained on historical sensor data associated with facility operations; and receiving data associated with the at least one anomaly as an output of the machine learned model.
E. The method any of A-D, wherein determining the probability associated with the at least one anomaly further comprises: selecting a first weight associated with the first sensor data based at least in part on a first type of sensor capturing the first sensor data and a current weather condition; selecting a second weight associated with the second sensor data based at least in part on a second type of sensor capturing the second sensor data and the current weather condition, the second type different than the first type; and the probability is based at least in part on the first weight and the second weight.
F. The method any of E, wherein: selecting the first weight associated with the first sensor data is based at least in part on a first location of the sensor capturing the first sensor data; and selecting the second weight associated with the second sensor is based at least in part on a second location of the sensor capturing the second sensor data.
G. The method any of A-F, wherein the alert includes an instruction to halt the operation.
H. The method any of A-G, wherein detecting the at least one anomaly associated with the operation further comprises: determining a current status associated with the operation; accessing a prior status associated with the operation; and detecting a change between the current status and the prior status.
I. The method any of H, wherein the current status and the prior status are associated with at least one of: a container associated with the operation; a vehicle associated with the operation; equipment associated with the operation; personnel associated with the operation; an asset associated with the operation; or a chassis associated with the operation.
J. The method any of A-I, wherein detecting the at least one anomaly associated with the operation further comprises: determining a condition associated with the operations that meets or exceeds one or more thresholds.
K. The method any of A-I, wherein the alert includes an instruction to personnel to perform a manual inspection of the operation.
L. A computer program product comprising coded instructions that, when run on a computer, implement a method as claimed in any of methods A-K.
M. A system comprising: one or more processors; and one or more non-transitory computer-readable media storing instructions that, when executed by the one or more processors, cause the one or more processors to perform operations comprising: receiving first sensor data associated with an operation at a facility; receiving second sensor data associated with the operation at the facility; transforming, based at least in part on a common model, the first sensor data and the second sensor data into first processed sensor data and second processed data; generating normalized sensor data based at least in part on the first sensor data and the second sensor data; detecting, based at least in part on the normalized data, at least one anomaly associated with the operation; determining a probability associated with the at least one anomaly; and sending, based at least in part on the probability, an alert to a system associated with the operation.
N. The system as recited in M, wherein determining the probability associated with the at least one anomaly further comprises: selecting a first weight associated with the first sensor data based at least in part on a first type of sensor capturing the first sensor data and a current weather condition; selecting a second weight associated with the second sensor data based at least in part on a second type of sensor capturing the second sensor data and the current weather condition, the second type different than the first type; and the probability is based at least in part on the first weight and the second weight.
O. The system as recited in M or N, wherein detecting the at least one anomaly associated with the operation further comprises: determining a current status associated with the operation; accessing a prior status associated with the operation; and detecting a change between the current status and the prior status.

While the example clauses described above are described with respect to one particular implementation, it should be understood that, in the context of this document, the content of the example clauses can also be implemented via a method, device, system, a computer-readable medium, and/or another implementation. Additionally, any of examples may be implemented alone or in combination with any other one or more of the other examples.

1. A method comprising:
receiving first sensor data associated with an operation at a facility;
receiving second sensor data associated with the operation at the facility;
transforming, based at least in part on a common model, the first sensor data and the second sensor data into first processed sensor data and second processed data;
generating normalized sensor data based at least in part on the first sensor data and the second sensor data;
detecting, based at least in part on the normalized data, at least one anomaly associated with the operation;
determining a probability associated with the at least one anomaly; and
sending, based at least in part on the probability, an alert to a system associated with the operation.

2. The method of claim 1, wherein the second sensor data has a different modality than the first sensor data.

3. The method of claim 1, wherein generating the normalized sensor data is based at least in part on threshold-based data normalization.

4. The method of claim 1, wherein detecting the at least one anomaly further comprises:
inputting the normalized data into one or more machine learned model or network trained on historical sensor data associated with facility operations; and
receiving data associated with the at least one anomaly as an output of the machine learned model.

5. The method of claim 1, wherein determining the probability associated with the at least one anomaly further comprises:
selecting a first weight associated with the first sensor data based at least in part on a first type of sensor capturing the first sensor data and a current weather condition;
selecting a second weight associated with the second sensor data based at least in part on a second type of sensor capturing the second sensor data and the current weather condition, the second type different than the first type; and
the probability is based at least in part on the first weight and the second weight.

6. The method of claim 5, wherein:
selecting the first weight associated with the first sensor data is based at least in part on a first location of the sensor capturing the first sensor data; and
selecting the second weight associated with the second sensor is based at least in part on a second location of the sensor capturing the second sensor data.

7. The method of claim 1, wherein the alert includes an instruction to halt the operation.

8. The method of claim 1, wherein detecting the at least one anomaly associated with the operation further comprises:
determining a current status associated with the operation;
accessing a prior status associated with the operation; and
detecting a change between the current status and the prior status.

9. The method of claim 8, wherein the current status and the prior status are associated with at least one of:
a container associated with the operation;
a vehicle associated with the operation;
equipment associated with the operation;
personnel associated with the operation;
an asset associated with the operation; or
a chassis associated with the operation.

10. The method of claim 1, wherein detecting the at least one anomaly associated with the operation further comprises:
determining a condition associated with the operations that meets or exceeds one or more thresholds.

11. The method of claim 1, wherein the alert includes an instruction to personnel to perform a manual inspection of the operation.

12. (canceled)

13. A system comprising:
one or more processors; and
one or more non-transitory computer-readable media storing instructions that, when executed by the one or more processors, cause the one or more processors to perform operations comprising:
receiving first sensor data associated with an operation at a facility;
receiving second sensor data associated with the operation at the facility;
transforming, based at least in part on a common model, the first sensor data and the second sensor data into first processed sensor data and second processed data;
generating normalized sensor data based at least in part on the first sensor data and the second sensor data;
detecting, based at least in part on the normalized data, at least one anomaly associated with the operation;
determining a probability associated with the at least one anomaly; and
sending, based at least in part on the probability, an alert to a system associated with the operation.

14. The system as recited in claim 13, wherein determining the probability associated with the at least one anomaly further comprises:
selecting a first weight associated with the first sensor data based at least in part on a first type of sensor capturing the first sensor data and a current weather condition;
selecting a second weight associated with the second sensor data based at least in part on a second type of sensor capturing the second sensor data and the current weather condition, the second type different than the first type; and
the probability is based at least in part on the first weight and the second weight.

15. The system of claim 13, wherein detecting the at least one anomaly associated with the operation further comprises:
determining a current status associated with the operation;
accessing a prior status associated with the operation; and
detecting a change between the current status and the prior status.

16. One or more non-transitory computer-readable media storing instructions that, when executed by the one or more processors, cause the one or more processors to perform operations comprising
receiving first sensor data associated with an operation at a facility;
receiving second sensor data associated with the operation at the facility;
transforming, based at least in part on a common model, the first sensor data and the second sensor data into first processed sensor data and second processed data;
generating normalized sensor data based at least in part on the first sensor data and the second sensor data;
detecting, based at least in part on the normalized data, at least one anomaly associated with the operation;
determining a probability associated with the at least one anomaly; and
sending, based at least in part on the probability, an alert to a system associated with the operation.

17. The method as recited in claim 16, wherein:
the second sensor data has a different modality than the first sensor data; and
generating the normalized sensor data is based at least in part on threshold-based data normalization.

18. The method as recited in claim 16, wherein detecting the at least one anomaly further comprises:
inputting the normalized data into one or more machine learned model or network trained on historical sensor data associated with facility operations; and
receiving data associated with the at least one anomaly as an output of the machine learned model.

19. The method as recited in claim 16, wherein determining the probability associated with the at least one anomaly further comprises:
selecting a first weight associated with the first sensor data based at least in part on a first type of sensor capturing the first sensor data and a current weather condition;
selecting a second weight associated with the second sensor data based at least in part on a second type of sensor capturing the second sensor data and the current weather condition, the second type different than the first type; and
the probability is based at least in part on the first weight and the second weight.

20. The method as recited in claim 19, wherein:
selecting the first weight associated with the first sensor data is based at least in part on a first location of the sensor capturing the first sensor data; and
selecting the second weight associated with the second sensor is based at least in part on a second location of the sensor capturing the second sensor data.

21. The method as recited in claim 16, wherein detecting the at least one anomaly associated with the operation further comprises:
determining a current status associated with the operation;
accessing a prior status associated with the operation; and
detecting a change between the current status and the prior status.
